(19) United States
(12) Patent Application Publication
(10) Pub. No.: US 2008/0174590 A1
(43) Pub. Date: Jul. 24, 2008

(54) Plasma display and driving method thereof

(76) Inventor: Yoo-Jin Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/998,328

(22) Filed: Nov. 29, 2007

(30) Foreign Application Priority Data
Jan. 22, 2007 (KR) 10-2007-0006565

(51) Int. Cl. G09G 5/00

(52) U.S. Cl. 345/212

(57) ABSTRACT

A plasma display and a driving method thereof are disclosed. The plasma display includes a power supply that supplies a plurality of voltages to a driver driving first electrodes through a plurality of fuses. The power supply supplies the plurality of fuses with a fuse driving voltage used to control the plurality of fuses. When an error occurs in the driver connected to a first fuse, the fuse driving voltage is not supplied to the plurality of fuses. Then, the entire operation of the driver is stopped. Therefore, elements of the driver, in which errors do not occur, can be prevented from being further damaged.

### CROSS-REFERENCE TO RELATED APPLICATION

This application claims priority to and the benefit of Korean Patent Application No. 10-2007-0006565 filed in the Korean Intellectual Property Office on Jan. 22, 2007, the entire content of which is incorporated herein by reference.

### BACKGROUND

1. Field

The field relates to a plasma display and a driving method thereof.

2. Description of the Related Technology

A plasma display is a display device that displays characters or images using plasma generated by gas discharge. Depending on its size, the plasma display panel includes more than tens to millions of pixels arranged in a matrix.

In general, the plasma display includes a plasma display panel (PDP), a controller, a driver, and a power supply. The plasma display panel (PDP) includes a plurality of address electrodes that extend in a column direction, and a plurality of sustain electrodes and a plurality of scan electrodes that are arranged in pairs and extend in a row direction. The controller receives an image signal, and outputs an address electrode driving control signal, a sustain electrode driving control signal, and a scan electrode driving control signal to the driver of each of the electrodes. The driver receives a control signal from the controller, applies a driving voltage to each of the electrodes, and can be divided into an address electrode driver, a sustain electrode driver, and a scan electrode driver. The power supply supplies a plurality of voltages and currents to the driver, the controller, and the plasma display panel (PDP).

FIG. 1 is a schematic view illustrating a power supply and a driver according to the related technology.

As shown in FIG. 1, a power supply 10 generates a plurality of DC voltages V1, V2, V3, . . . , and Vn, which are used in a plasma display, and supplies the plurality of DC voltages to a driver 20 of each electrode. The plurality of DC voltages output from the power supply 10 are supplied to the driver 20 through fuses F1, F2, F3, . . . , and Fn, respectively. Each of the fuses is opened when the driver connected to each fuse performs an abnormal operation, such that the voltage is not supplied to the corresponding driver that performs the abnormal operation. Therefore, the plasma display is protected by stopping the operation of the driver that performs the abnormal operation.

However, in the related art, when a first driver 21 performs an abnormal operation, the first fuse F1 is only opened. Therefore, in a state where the first driver 21 stops its operation, a second or third driver 22 or 23 performs an operation, and secondary damage may occur, that is, the second or third driver 22 or 23 may be further damaged after the first driver 21.

The above information disclosed in this Background section is only for enhancement of understanding of the background of the invention and therefore it may contain information that does not form the prior art that is already known in this country to a person of ordinary skill in the art.

### SUMMARY OF CERTAIN INVENTIVE ASPECTS

One aspect is a plasma display, including first electrodes, a driver configured to drive the first electrodes, a power supply configured to supply a plurality of voltages to the driver through a plurality of fuses, a first power source in the power supply configured to supply a fuse driving voltage for the plurality of fuses, and a first switch connected between the first power source and the plurality of fuses, the first switch configured to selectably connect the fuse driving voltage to the plurality of fuses. The display also includes an error detector configured to detect a voltage across each of the plurality of fuses, to compare each of the detected voltages with a plurality of reference voltages, and to generate a control signal to be used to determine whether to connect the fuse driving voltage to the plurality of fuses.

Another aspect is a plasma display, including first electrodes, a driver configured to drive the first electrodes, a power supply configured to supply a plurality of voltages to the driver through a plurality of fuses, and a plurality of switches in the driver, connected between the first electrodes and the power supply, the switches configured to selectably connect the plurality of voltages to the first electrodes. The display also includes a power source in the power supply configured to supply a switch driving voltage for the plurality of switches, and a power source switch connected between the power source and the plurality of switches, the power source switch configured to selectably connect the power source to the plurality of switches. The display also includes an error detector configured to detect a voltage across each of the plurality of fuses, to compare each of the detected voltages with a plurality of reference voltages, and to generate a control signal to be used to determine whether to connect the power source to the plurality of switches.

Another aspect is a method of driving a plasma display which includes first electrodes, a driver driving the first electrodes, and a power supply supplying a plurality of voltages to the driver through a plurality of fuses. The method includes detecting a voltage across each of the plurality of fuses, comparing the detected voltages with a plurality of reference voltages, and disconnecting a fuse driving voltage from the plurality of fuses when at least one detected voltage is greater than a corresponding reference voltage.

Another aspect is a method of driving a plasma display which includes first electrodes, a driver driving the first electrodes, a power supply supplying a plurality of voltages to the driver through a plurality of fuses, and a plurality of switches in the driver selectably connecting a plurality of voltages to the first electrodes. The method includes detecting a voltage across each of the plurality of fuses, comparing a plurality of detected voltages with a plurality of reference voltages, and disconnecting the plurality of switches from a switch driving voltage when at least one detected voltage is greater than a corresponding reference voltage.

Another aspect is a plasma display device, including first electrodes, a driver driving the first electrodes, a power supply supplying a plurality of voltages to the driver through a plurality of fuses, means for detecting a voltage across each of the plurality of fuses, means for comparing the detected voltages with a plurality of reference voltages, and means for disconnecting a fuse driving voltage from the plurality of fuses when at least one detected voltage is greater than a corresponding reference voltage.

Another aspect is a plasma display device, including first electrodes, a driver driving the first electrodes, a power supply supplying a plurality of voltages to the driver through a plurality of fuses, a plurality of switches in the driver selectably connecting a plurality of voltages to the first electrodes, means for detecting a voltage across each of the plurality of fuses, means for comparing a plurality of detected voltages with a plurality of reference voltages, and means for disconnecting the plurality of switches from a switch driving voltage when at least one detected voltage is greater than a corresponding reference voltage.

### BRIEF DESCRIPTION OF THE DRAWINGS

FIG. 1 is a schematic view illustrating a power supply and drivers according to the related art.

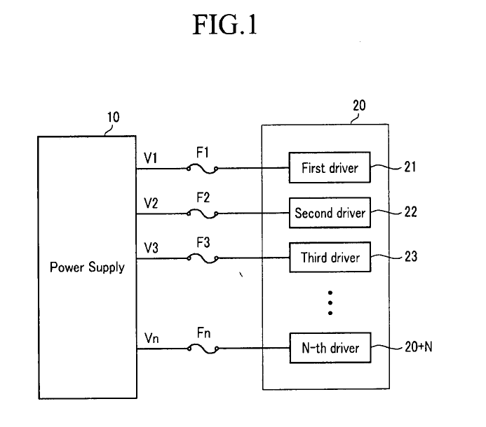

FIG. 2 is a view illustrating a plasma display according to one embodiment.

FIG. 3 is a view illustrating a driving circuit of a scan electrode driver 400 of FIG. 2.

FIG. 4 is a view illustrating a plasma display including a first error detector that detects a fuse according to an embodiment.

FIG. 5 is a view illustrating the internal structure of a first error detector 700 shown in FIG. 4.

FIG. 6 is a view illustrating a plasma display including a second error detector that detects a fuse according to an embodiment.

FIG. 7 is a view illustrating the internal structure of a second error detector 800 shown in FIG. 6.

### DETAILED DESCRIPTION OF CERTAIN INVENTIVE EMBODIMENTS

In the following detailed description, only certain embodiments of the present invention have been shown and described, simply by way of illustration. As those skilled in the art would realize, the described embodiments may be modified in various ways, without departing from the spirit or scope of the present invention. Accordingly, the drawings and description are to be regarded as illustrative in nature and not restrictive. Like reference numerals generally designate like elements throughout the specification. In addition, certain parts not related to the description are omitted for clear description.

The term “wall charges” used herein means charges formed on a wall close to each electrode of a cell (for example, a dielectric layer). Although the wall charges do not touch the electrodes, the wall charges will be described as being “formed” or “accumulated” on the electrode. The term “wall voltage” means a potential difference formed on the wall of the cell by the wall charges.

Hereinafter, a plasma display and a driving method thereof according to one embodiment will be described in detail with reference to the accompanying drawings.

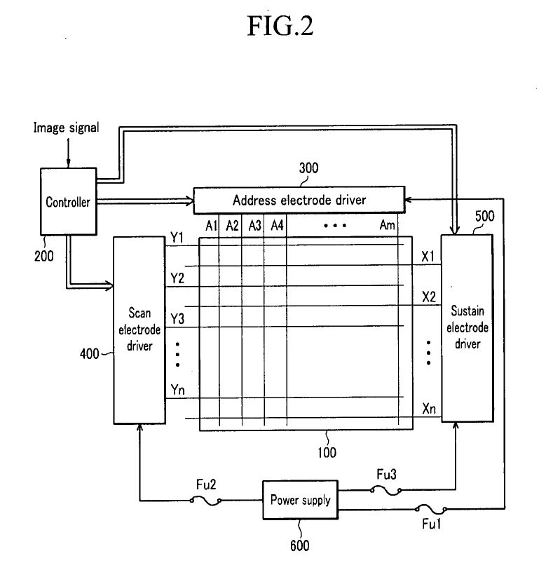

FIG. 2 is a view illustrating a plasma display according to one embodiment.

As shown in FIG. 2, a plasma display includes a plasma display panel (PDP) 100, a controller 200, an address electrode driver 300, a scan electrode driver 400, a sustain electrode driver 500, and a power supply 600. Further, the drivers 300, 400, and 500 and the power supply 600 of the respective electrodes are connected to one another with fuses Fu1, Fu2, and Fu3 interposed therebetween.

The plasma display panel (PDP) 100 includes a plurality of address electrode A1 to Am that extend in a column direction, and a plurality of sustain electrodes X1 to Xn scan electrodes Y1 to Yn that are arranged in pairs and extend in a row direction. The sustain electrodes X1 to Xn are formed to correspond to the respective scan electrodes Y1 to Yn. The sustain electrodes X1 to Xn and the scan electrodes Y1 to Yn perform a display operation displaying an image during a sustain period. The address electrodes A1 to Am are disposed substantially orthogonal to the sustain electrodes X1 to Xn and the scan electrodes Y1 to Yn. Discharge spaces near intersections of the address electrodes A1 to Am, the sustain electrodes X1 to Xn, and the scan electrodes Y1 to Yn form discharge cells. The above-described structure of the plasma display panel 100 is just an example. A panel having a different structure, to which a driving method to be described below can be applied may be used.

The controller 200 receives an image signal and outputs an address electrode driving control signal, a sustain electrode driving control signal, and a scan electrode driving control signal. The controller 200 performs driving by dividing each frame into a plurality of subfields. Each subfield includes a reset period, an address period, and a sustain period in a temporal operation variation manner.

The address electrode driver 300 receives the address electrode driving control signal from the control device 200 and applies display data signals for selecting the desired discharge cells to the individual address electrodes.

The scan electrode driver 400 receives the scan electrode driving control signal from the controller 200 and applies a driving voltage, which is supplied from the power supply 600, to the scan electrodes.

The sustain electrode driver 500 receives the sustain electrode driving control signal from the controller 200 and applies a driving voltage, which is supplied from the power supply 600, to the sustain electrodes.

The power supply 600 supplies a voltage to the individual drivers 300, 400, and 500 through the plurality of fuses Fu1, Fu2, and Fu3. Each of the drivers 300, 400, and 500 does not operate when the voltage is not supplied from the power supply 600. Further, the first to third fuses Fu1, Fu2, and Fu3 do not operate when a voltage Vff used to drive the fuses (hereinafter, referred to as “fuse driving voltage Vff”) is not applied from the power supply 600.

In FIG. 2, one voltage is applied through the fuse Fu1 from the power supply 600 to the address electrode driver 300. However, a plurality of voltages are applied from the power supply 600 to the address electrode driver 300 through a plurality of fuses (not shown) in addition to the first fuse Fu1. Further, a plurality of voltages are applied from the power supply 600 to each of the scan electrode driver 400 and the sustain electrode driver 500 through a plurality of fuses (not shown) in addition to each of the second and third fuses Fu2 and Fu3.

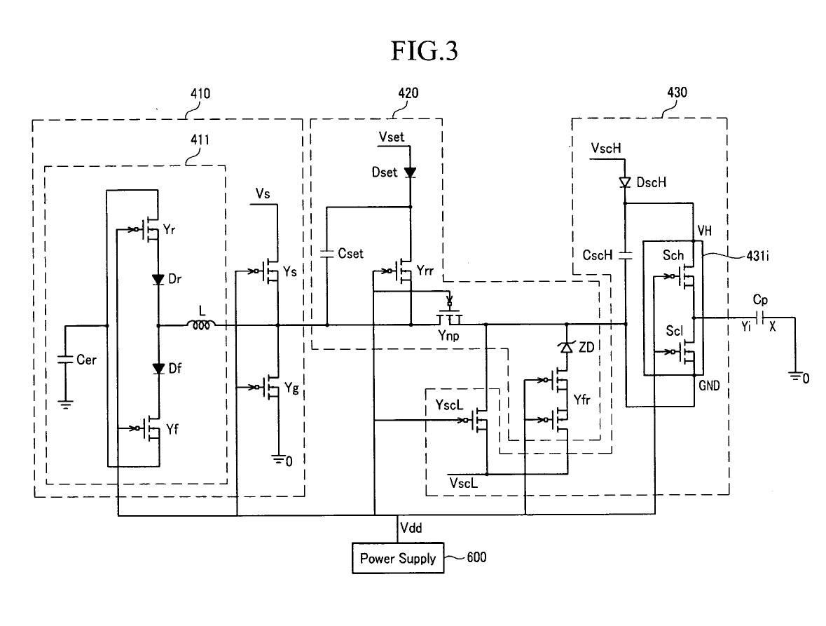

FIG. 3 is a view illustrating a driving circuit of a scan electrode driver 400 of FIG. 2.

FIG. 3 illustrates one scan circuit 431i that is connected to one scan electrode Y1. Further, in FIG. 3, a plurality of transistors are n-channel effect transistors, and particularly, NMOS (n-channel metal oxide semiconductor) transistors. In each of the transistors, a body diode may be formed in a direction toward a drain from a source. Alternatively, the transistors shown in FIG. 3 may be replaced with different transistors having a similar function as the NMOS transistors. Further, in FIG. 3, each of the transistors is composed of one transistor. However, each of the transistors may be composed of a plurality of transistors that are connected in parallel to each other. A capacitive component formed by each of the sustain electrodes X1 to Xn and each of the scan electrodes Y1 to Yn is shown as a panel capacitor Cp.

Herein, the transistors are only driven when a driving voltage Vdd used to drive the transistors (hereinafter, referred to as “switch driving voltage Vdd”) is input from the power supply 600. Further, as shown in FIG. 3, power sources Vset, Vs, VscH, VscL, and 0 V are supplied from the power supply 600 through the plurality of fuses Fu1 to Fu3.

As shown in FIG. 3, the scan electrode driver 400 includes a sustain driver 410, a reset driver 420, and a scan driver 430.

The sustain driver 410 includes an energy recovery unit 411 and transistors Ys and Yg. The energy recovery unit 411 includes transistors Yr and Yf, an inductor L, diodes Dr and Df, and a capacitor Cer.

The transistor Ys is connected between the power source Vs, which supplies a voltage of Vs, and the Y electrode of the panel capacitor Cp. The transistor Yg is connected between the power source 0 V, which supplies a voltage of 0 V, and the Y electrode of the panel capacitor Cp. The transistor Ys applies the voltage of Vs to the Y electrode through reset driver 420 and scan driver 430, and the transistor Yg applies the voltage of 0 V to the Y electrode through reset driver 420 and scan driver 430.

A first terminal of the capacitor Cer is connected to a node between the transistors Ys and Yg. An average voltage Vs/2 between the voltage Vs and the voltage of 0 V is charged in the capacitor Cer. Further, a source of the transistor Yr is connected to a second terminal of the inductor L that has a first terminal connected to the Y electrode, and a drain of the transistor Yr is connected to the first terminal of the capacitor Cer. A drain of the transistor Yf is connected to the second terminal of the inductor L, and a source of the transistor Yf is connected to the first terminal of the capacitor Cer.

Further, the diode Dr is connected between the source of the transistor Yr and the inductor L, and the diode Df is connected between the drain of the transistor Yf and the inductor L. When the transistor Yr has a body diode, the diode Dr is for setting a rising path through which the voltage of the Y electrode increases. When the transistor Yf has a body diode, the diode Df is for setting a falling path through which the voltage of the Y electrode decreases. When each of the transistors Yr and Yf does not have the body diode, each of the diodes Dr and Df may be removed so as to connect transistors Yr and Yf to inductor L. The energy recovery unit 411 having the above-described connection increases the voltage of the Y electrode from the voltage of 0 V to the voltage Vs or decreases the voltage Vs to the voltage of 0 V by using resonance of the inductor L and the panel capacitor Cp.

Meanwhile, in the energy recovery unit 411, the order in which the inductor L, the diode Df, and the transistor Yf are connected may be changed, and the order in which the inductor L, the diode Dr, and the transistor Yr are connected may also be changed. For example, the inductor L may be connected between a node between the transistors Yr and Yf and the capacitor Cer for energy recovery. Further, in FIG. 3, the inductor L is connected to the node between the transistors Yr and Yf. However, inductors may be connected to the rising path formed by the transistor Yr and the falling path formed by the transistor Yf, respectively.

The reset driver 420 includes transistors Yrr and Yfr, a capacitor Cset, a Zenor diode ZD, and a diode Dset. The reset driver 420 gradually increases the voltage of the Y electrode from the voltage Vs to the voltage Vset during a rising period of the reset period, and gradually decreases the voltage of the Y electrode from the voltage Vs to the voltage Vnf during a falling period of the reset period. The transistor Yrr has a drain connected to the power source Vset supplying the voltage Vset and a source connected to the Y electrode of the panel capacitor Cp. The diode Dset is formed in an opposite direction to the body diode of the transistor Yrr in order to block a current formed by the body diode of the transistor Yrr. The transistor Yfr is connected between the power source VscL, which supplies the VscL voltage, and the Y electrode of the panel capacitor Cp. Since in the driving circuit of FIG. 3, the voltage Vnf is larger than voltage VscL, the transistor Yfr is connected to a cathode of the Zenor diode ZD. Here, it is assumed that the voltage Vnf is greater than the voltage VscL by a breakdown voltage. Further, since the voltage Vnf is larger than the voltage VscL, when the transistor YscL is turned on, a current path may be formed through the body diode of the transistor Yfr. Therefore, in order to block the current path through the body diode of the transistor Yfr, the transistor Yfr may be formed in a back-to-back type.

The scan driver 430 includes a selection circuit 431, a capacitor CscH, and a transistor YscL. The scan driver 430 applies the voltage VscL to the scan electrodes in order to select discharge cells to be turned on during the address period, and applies voltage VscH to the scan electrodes of discharge cells not to be turned on. In general, in order to sequentially select the plurality of Y electrodes Y1 to Yn during the address period, the selection circuit 431 that is integrated into an integrated circuit (IC) is connected to each of the Y electrodes Y1 to Yn. The driving circuit of the scan electrode driver 400 is connected in common to the Y electrodes Y1 to Yn by the selection circuits 431. In FIG. 3, the selection circuit 431 that is connected to one Y electrode is only illustrated.

The selection circuit 431 includes transistors Sch and Scl. A source of the transistor Sch and a drain of the transistor Scl are individually connected to the Y electrode of the panel capacitor Cp. A first terminal of the capacitor CscH is connected to a node between a source of the transistor Scl and a drain of the transistor Sch. A second terminal of the capacitor CscH is connected to a drain of the transistor Sch. The transistor YscL is connected between the power source VscL and the Y electrode of the panel capacitor Cp. A diode DscH has an anode connected to the power source VscH supplying the voltage VscH and a cathode connected to the drain of the transistor Scl. Here, the transistor YscL is turned on and a (VscH-VscL) voltage is charged in the capacitor CscH.

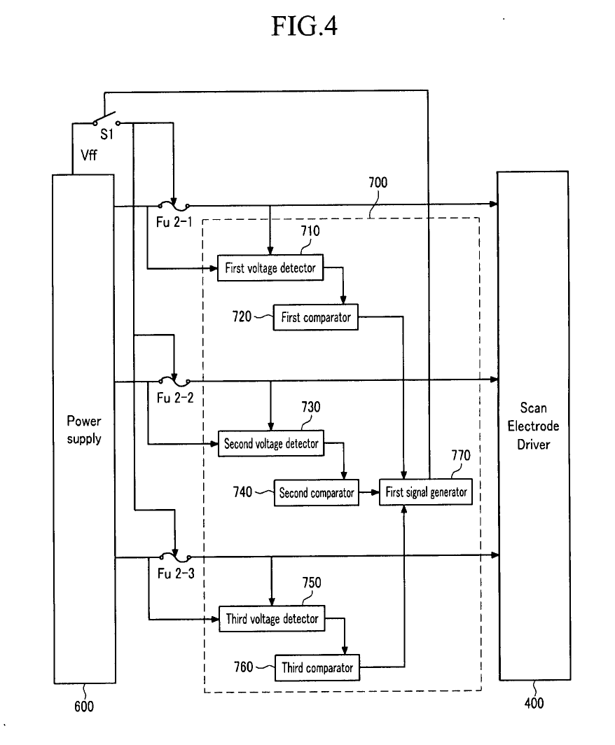

FIG. 4 is a view illustrating a plasma display including a first error detector that detects a fuse.

In FIG. 4, for the convenience of explanation, the power supply 600 applies three voltages Vset, Vs, and Vsch to the scan electrode driver 400 through three fuses Fu2-1, Fu2-2, and Fu2-3. However, the power supply 600 applies more kinds of voltages (including voltage Vsc1 and voltage 0 V shown in FIG. 3) (not shown) to the scan electrode driver 400 through a larger number of fuses. However, the present invention is not limited to the scan electrode driver 400, and can be applied to the address electrode driver 300 and the sustain electrode driver 500 that are supplied with the voltages by the power supply 600.

As shown in FIG. 4, the plasma display according to one embodiment includes a switch S1 and a first error detector 700. The first error detector 700 includes first to third voltage detectors 710, 730, and 750, first to third comparators 720, 740, and 760, and a first signal generator 770.

More specifically, the switch S1 is connected between the power supply 600 and the respective fuses Fu2-1, Fu2-2, and Fu2-3, and the switch S1 performs a switching operation on whether or not to apply a fuse driving voltage Vff to the respective fuses Fu2-1, Fu2-2, and Fu2-3.

The first voltage detector 710 detects a voltage across the fuse Fu2-1, the second voltage detector 730 detects a voltage across the fuse Fu2-2, and the third voltage detector 750 detects a voltage across the fuse Fu2-3. In general, when each of the fuses performs a normal operation, the voltage across the fuses is 0 V. However, when the drivers (scan electrode driver, sustain electrode driver, address electrode driver, and the like) that are connected to the fuses perform an abnormal operation, the voltages that are output from the power supply 600 are not appropriately used in each of the drivers, and thus the voltage across the fuses changes. In some embodiments, an error occurs in the driver connected to the fuses by detecting a change in voltage across the fuse.

The first comparator 720 compares a first detection voltage detected by the first voltage detector 710 and a first reference voltage Vref1 that is set, and outputs a low signal L to the first signal generator 770 when the first detection voltage is larger than the first reference voltage. The second comparator 740 compares a second detection voltage detected by the second voltage detector 730 and a second reference voltage Vref2 that is set, and outputs a low signal L to the first signal generator 770 when the second detection voltage is larger than the second reference voltage. Further, the third comparator 760 compares a third detection voltage detected by the third voltage detector 750 and a third reference voltage Vref3 that is set, and outputs a low signal L to the first signal generator 770 when the third detection voltage is larger than the third reference voltage. When the first to third detection voltages are smaller than the first to third reference voltages, each of the first to third comparators 720, 740, and 760 outputs a high signal H. Here, each of the first to third reference voltages may be set to the minimum voltage across each of the first to third fuses when each fuse performs an abnormal operation or when an error occurs.

The first signal generator 770 outputs a signal for turning off the switch S1 when the low signal L is output from any one of the first to third comparators 720, 740, and 760. At this time, the switch S1 is turned off such that the fuse driving voltage Vff applied to the fuses Fu2-1, Fu2-2, and Fu2-3 is blocked. Then, the plurality of voltages that are applied to the scan electrode driver 400 through the fuses Fu2-1, Fu2-2, and Fu2-3 are blocked. That is, in some embodiments, when the voltage of one fuse connected to the driver is larger than the reference voltage, the fuse driving voltage Vff applied to all the fuses is blocked to thereby block all of the voltages that are applied to the scan electrode driver 400. Therefore, the scan electrode driver 400 stops performing the operation because the voltages are not applied to the scan electrode driver 400. Therefore, even when an error occurs in one driver connected to a terminal of one voltage among the plurality of voltages that are applied to the scan electrode driver 400, the scan electrode driver 400 stops performing the operation. Therefore, other elements forming the scan electrode driver 400 can be prevented from being further damaged.

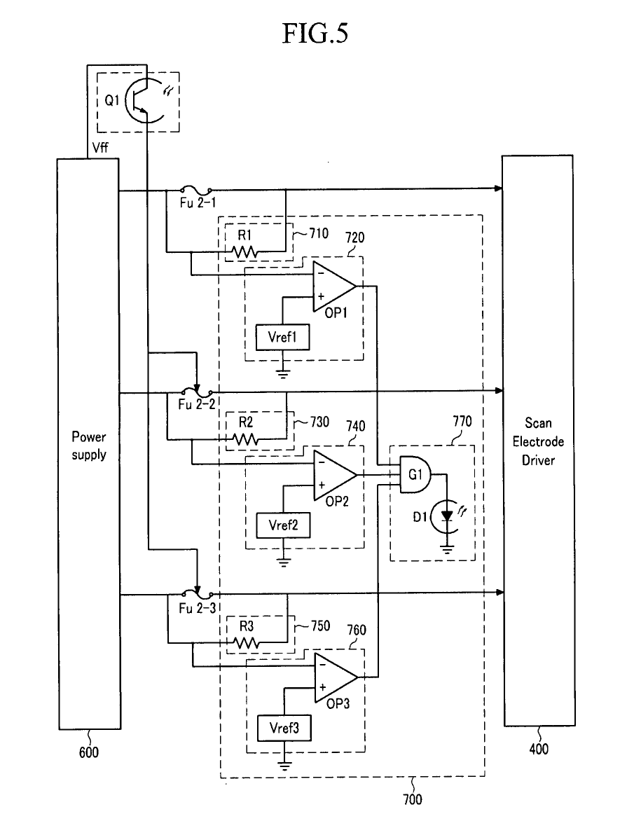

FIG. 5 is a view illustrating the internal structure of a first error detector 700 shown in FIG. 4.

As shown in FIG. 5, the first voltage detector 710 includes a first detecting resistor R1 that is connected between the both ends of the fuse Fu2-1. The second voltage detector 730 includes a second detecting resistor R2 that is connected between the both ends of the fuse Fu2-2. The third voltage detector 750 includes a third detecting resistor R3 that is connected between the both ends of the fuse Fu2-3. The first comparator 720 includes a comparator OP1, the second comparator 740 includes a comparator OP2, and the third comparator 760 includes a comparator OP3. The first signal generator 770 includes an AND gate, and a light emitting diode D1 that is coupled to the switch S1 where the switch S1 is a light receiving transistor. Outputs of the comparators OP1, OP2, and OP3 are input to the AND gate. The voltage is only applied to the light emitting diode D1 when the outputs of the comparator OP1, OP2, and OP3 are all high signals H. That is, when the low signal L is input from any one of the comparators OP1, OP2, and OP3, the AND gate G1 does not apply the voltage to the light emitting diode D1.

Here, a current in proportion to the voltage across each of the fuses Fu2-1, Fu2-2, and Fu2-3 flows through each of the detecting resistors R1, R2, and R3. In FIG. 5, each of the detecting resistors R1, R2, and R3 is used to detect the voltage across each of the fuses Fu2-1, Fu2-2, and Fu2-3. However, the detecting resistors R1, R2, and R3 may be replaced with hall sensors, current transformers and the like.

The comparator OP1 has an inversion terminal (−) to which a first detection voltage V1 corresponding to an output current flowing through the first detecting resistor R1 is input. The comparator OP1 has a non-inversion terminal (+) to which the first reference voltage Vref1 is input. When the first detection voltage V1 input to the inversion terminal (−) is larger than the first reference voltage Vref1 (i.e., when an error occurs in the driver connected to the fuse Fu2-1), the comparator OP1 outputs a low signal L to the first signal generator 770. However, when the first detection voltage V1 is smaller than the first reference voltage Vref1 (i.e., when the driver connected to the fuse Fu2-1 performs a normal operation), the comparator OP1 outputs a high signal H to the first signal generator 770. In the same way, each of the comparators OP2 and OP3 outputs a low signal L or a high signal H to the first signal generator 770.

When signals that are input to the AND gate GI of the first signal generator 770 are all high signals H, the voltage is applied to the light emitting diode D1. Then, the light emitting diode D1 emits light such that the light receiving transistor Q1 (the same as the switch S1 in FIG. 4) is turned on. When the light receiving transistor Q1 is turned on, the fuse driving voltage Vff is applied from the power supply 600 to the fuses Fu2-1, Fu2-2, and Fu2-3. Then, each of the fuses Fu2-1, Fu2-2, and Fu2-3 driven by the fuse driving voltage Vff performs a normal operation, such that the plurality of voltages are applied to the scan electrode driver 400.

In contrast, when at least one signal among the signals applied to the AND gate G1 of the first signal generator 770 is the low signal L, the voltage is not applied to the light emitting diode D1. Then, the light receiving transistor Q1 is turned off because the light emitting diode D1 does not emit light. When the light receiving transistor Q1 is turned off, the power supply 600 does not apply the fuse driving voltage Vff to the fuses Fu2-1, Fu2-2, and Fu2-3. Then, each of the fuses Fu2-1, Fu2-2, and Fu2-3 to which the fuse driving voltage Vff is not applied stops performing the operation, such that the plurality of voltages that are applied to the scan electrode driver 400 are blocked. Therefore, the entire operation of the scan electrode driver 400 is stopped, thereby preventing other elements forming the scan electrode driver 400 from being further damaged.

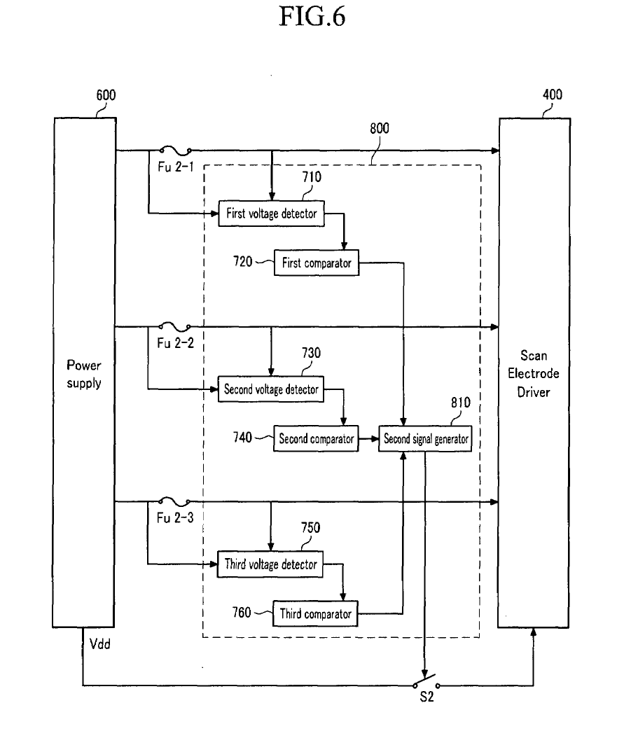

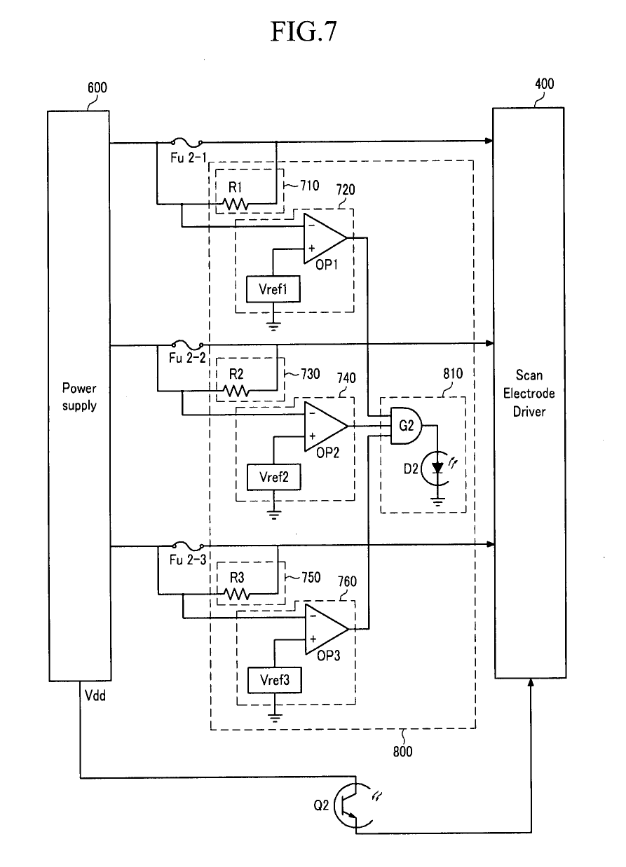

FIG. 6 is a view illustrating a plasma display including a second error detector that detects a fuse according to another embodiment. FIG. 7 is a view illustrating the internal structure of a second error detector 800 shown in FIG. 6.

As shown in FIG. 6, the plasma display includes a switch S2 and the second error detector 800.

More specifically, the switch S2 is connected between a power supply 600 and a plurality of transistors Yr, Yf, Ys, Yg, Yrr, YscL, YscH, Yrf, Scl, and Sch in the scan electrode driver 400. The switch S2 performs a switching operation on whether or not to apply a switch driving voltage Vdd to the plurality of transistors Yr, Yf, Ys, Yg, Yrr, YscL, YscH, Yrf, Scl, and Sch.

The second error detector 800 has the similar structure and operation as the first error detector 700.

As shown in FIG. 7, the second signal generator 810 includes an AND gate G2, and a light emitting diode D2 that is coupled to the switch S2 when the switch S2 is a light receiving transistor. Outputs of the comparators OP1, OP2, and OP3 are input to the AND gate G2. The voltage is only applied to the light emitting diode D2 when the outputs of the comparator OP1, OP2, and OP3 are all high signals H. That is, when the low signal L is input from any one of the comparators OP1, OP2, and OP3, the AND gate G2 does not apply the voltage to the light emitting diode D2.

More specifically, the voltage is applied to the light emitting diode D2 when the signals input to the AND gate G2 of the second signal generator 810 are all high signals H. Then, the light emitting diode D2 emits light, such that a light receiving transistor Q2 (the same as the switch S2 of FIG. 6) is turned on. When the light receiving transistor Q2 is turned on, the power supply 600 applies a switch driving voltage Vdd to the plurality of transistors Yr, Yf, Ys, Yg, Yrr, YscL, YscH, Yrf, Scl, and Sch. Then, each of the plurality of transistors Yr, Yf, Ys, Yg, Yrr, YscL, YscH, Yrf, Scl, and Sch driven by the switch driving voltage Vdd performs a normal operation, such that scan electrode driver 400 performs a normal operation.

In contrast, when at least one signal among the signals input to the AND gate G2 of the second signal generator 810 is the low signal L, the voltage is not applied to the light emitting diode D2. Then, since the light emitting diode D2 does not emit light, the light receiving transistor Q2 is turned off. When the light receiving transistor Q2 is turned off, the power supply 600 does not apply the switch driving voltage Vdd to the plurality of transistors Yr, Yf, Ys, Yg, Yrr, YscL, YscH, Yrf, Scl, and Sch. Then, the operation of each of the plurality of transistor Yr, Yf, Ys, Yg, Yrr, YscL, YscH, Yrf, Scl, and Sch to which the switch driving voltage Vdd is not applied is stopped. Therefore, the operation of the scan electrode driver 400 is stopped. Therefore, even when an error occurs in the driver connected to a terminal of any one voltage among the plurality of voltages applied to the scan electrode driver 400, the scan electrode driver 400 stops the operation, thereby preventing other elements forming the scan electrode driver 400 from being further damaged.

While this invention has been described in connection with what is presently considered to be practical embodiments, it is to be understood that the invention is not limited to the disclosed embodiments, but, on the contrary, is intended to cover various modifications and equivalent arrangements.

What is claimed is:

1. A plasma display, comprising:
first electrodes;
a driver configured to drive the first electrodes;
a power supply configured to supply a plurality of voltages to the driver through a plurality of fuses;
a first power source in the power supply configured to supply a fuse driving voltage for the plurality of fuses;
a first switch connected between the first power source and the plurality of fuses, the first switch configured to selectably connect the fuse driving voltage to the plurality of fuses; and
an error detector configured to detect a voltage across each of the plurality of fuses, to compare each of the detected voltages with a plurality of reference voltages, and to generate a control signal to be used to determine whether to connect the fuse driving voltage to the plurality of fuses.

2. The plasma display of claim 1, wherein the error detector is configured to turn off the first switch when at least one of the detected voltages is larger than a corresponding reference voltage, and to turn on the first switch when the plurality of detected voltages are each less than the corresponding reference voltages.

3. The plasma display of claim 1, wherein the error detector comprises:
a plurality of voltage detectors, each of which are configured to detect a voltage across one of the plurality of fuses;
a plurality of comparators, each configured to output a low signal when the corresponding detected voltage is greater than a corresponding reference voltage; and
a signal generator configured to generate a signal for turning off the first switch when any comparator of the plurality of comparator outputs the low signal.

4. The plasma display of claim 3, wherein each of the plurality of comparators includes an operational amplifier having an inversion terminal to which one of the plurality of detected voltages is input and a non-inversion terminal to which one of the plurality of reference voltages is input.

5. The plasma display of claim 3,
wherein the signal generator comprises a light emitting diode coupled to the first switch, and the first switch comprises a light receiving transistor, and
wherein the light emitting diode emits light when the plurality of comparators all output high signals and does not emit light when at least one low signal is output from the plurality of comparators.

6. The plasma display of claim 3, wherein first and second voltage detectors include detecting resistors that are electrically connected between both ends of first and second fuses, respectively, and detect first and detection voltages, respectively.

7. A plasma display, comprising:
first electrodes;
a driver configured to drive the first electrodes;
a power supply configured to supply a plurality of voltages to the driver through a plurality of fuses;
a plurality of switches in the driver that are connected between the first electrodes and the power supply, the switches being configured to selectably connect the plurality of voltages to the first electrodes;
a power source in the power supply configured to supply a switch driving voltage for the plurality of switches;
a power source switch connected between the power source and the plurality of switches, the power source switch configured to selectably connect the power source to the plurality of switches; and
an error detector configured to detect a voltage across each of the plurality of fuses, to compare each of the detected voltages with a plurality of reference voltages, and to generate a control signal to be used to determine whether to connect the power source to the plurality of switches.

8. The plasma display of claim 7, wherein the error detector is configured to turn off the power source switch when at least one of the detected voltages is larger than a corresponding reference voltage, and to turn on the power source switch when the plurality of detection voltages are each less than the corresponding reference voltages.

9. The plasma display of claim 7, wherein the error detector comprises:
a plurality of voltage detectors, each of which are configured to detect a voltage across one of the plurality of fuses;
a plurality of comparators, each configured to output a low signal when the corresponding detected voltage is greater than a corresponding reference voltage; and
a signal generator configured to generate a signal for turning off the power source switch when any comparator of the plurality of comparators outputs the low signal.

10. The plasma display of claim 9, wherein first and second voltage detectors include detecting resistors that are electrically connected between both ends of first and second fuses, respectively, and detect first and second detection voltages, respectively.

11. The plasma display of claim 9, wherein each of the plurality of comparators includes an operational amplifier having an inversion terminal to which one of the plurality of detected voltages is input and a non-inversion terminal to which each of the plurality of reference voltages is input.

12. The plasma display of claim 9,
wherein the signal generator comprises a light emitting diode coupled to the first switch, and the first switch comprises a light receiving transistor, and
wherein the light emitting diode emits light when the plurality of comparators all output high signals and does not emit light when at least one low signal is output from the plurality of comparators.

13. A method of driving a plasma display which includes first electrodes, a driver driving the first electrodes, and a power supply supplying a plurality of voltages to the driver through a plurality of fuses, the method comprising:
detecting a voltage across each of the plurality of fuses;
comparing the detected voltages with a plurality of reference voltages; and
disconnecting a fuse driving voltage from the plurality of fuses when at least one detected voltage is greater than a corresponding reference voltage.

14. The method of claim 13, further comprising:
connecting the fuse driving voltage to the plurality of fuses when the plurality of detection voltages are less than the corresponding reference voltages.

15. A method of driving a plasma display which includes first electrodes, a driver driving the first electrodes, a power supply supplying a plurality of voltages to the driver through a plurality of fuses, and a plurality of switches in the driver selectably connecting a plurality of voltages to the first electrodes, the method comprising:
detecting a voltage across each of the plurality of fuses;
comparing a plurality of detected voltages with a plurality of reference voltages; and
disconnecting the plurality of switches from a switch driving voltage when at least one detected voltage is greater than a corresponding reference voltage.

16. The method of claim 15, further comprising:
connecting the switch driving voltage to the plurality of switches when the plurality of detection voltages are each less than the plurality of corresponding reference voltages.

17. A plasma display device, comprising:
first electrodes;
a driver driving the first electrodes;
a power supply supplying a plurality of voltages to the driver through a plurality of fuses;
means for detecting a voltage across each of the plurality of fuses;
means for comparing the detected voltages with a plurality of reference voltages; and
means for disconnecting a fuse driving voltage from the plurality of fuses when at least one detected voltage is greater than a corresponding reference voltage.

18. The device of claim 17, further comprising:
means for connecting the fuse driving voltage to the plurality of fuses when the plurality of detection voltages are less than the corresponding reference voltages.

19. A plasma display device, comprising:
first electrodes;
a driver driving the first electrodes;
a power supply supplying a plurality of voltages to the driver through a plurality of fuses;
a plurality of switches in the driver selectably connecting a plurality of voltages to the first electrodes;
means for detecting a voltage across each of the plurality of fuses;
means for comparing a plurality of detected voltages with a plurality of reference voltages; and
means for disconnecting the plurality of switches from a switch driving voltage when at least one detected voltage is greater than a corresponding reference voltage.

20. The device of claim 19, further comprising:
means for connecting the switch driving voltage to the plurality of switches when the plurality of detection voltages are each less than the plurality of corresponding reference voltages.
